(19) United States
(12) Patent Application Publication
(10) Pub. No.: US 2008/0089578 A1
(43) Pub. Date: Apr. 17, 2008

(54) Method and Apparatus to Facilitate Use Of Conditional Probabilistic Analysis Of Multi-Point-Of-Reference Samples of an Item To Disambiguate State Information as Pertains to the Item

(75) Inventors: Wei Qu, Chicago, IL (US); Dan Schonfield, Glenview, IL (US); Magdi A. Mohamed, Schaumburg, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/614,361

(22) Filed: Dec. 21, 2006

Related U.S. Application Data
(63) Continuation-in-part of application No. 11/549,542, filed on Oct. 13, 2006.

(51) Int. Cl. G06K 9/00

(52) U.S. Cl. 382/154

(57) ABSTRACT

Temporally parsed data regarding at least a first item is captured (101). This temporally parsed data comprises data that corresponds to substantially simultaneous sequential samples of the first item with respect to at least a first and a second different points of view. Conditional probabilistic analysis of at least some of this temporally parsed data is then automatically used (102) to disambiguate state information as pertains to this first item. This conditional probabilistic analysis comprises analysis of at least some of the temporally parsed data as corresponds in a given sample to both the first point of reference and the second point of reference.

### CROSS REFERENCE TO RELATED APPLICATIONS

This is a continuation-in-part of prior application Ser. No. 11/549,542, filed Oct. 13, 2006, which is hereby incorporated herein by reference in its entirety.

### TECHNICAL FIELD

This invention relates generally to the tracking of multiple items.

### BACKGROUND

The tracking of multiple objects (such as, but not limited to, objects in a video sequence) is known in the art. Considerable interest exists in this regard as successful results find application in various use case settings, including but not limited to target identification, surveillance, video coding, and communications. The tracking of multiple objects becomes particularly challenging when objects that are similar in appearance draw close to one another or present partial or complete occlusions. In such cases, modeling the interaction amongst objects and solving the corresponding data association problem comprises a significant problem.

A widely adopted solution to address this need uses a centralized solution that introduces a joint state space representation that concatenates all of the object's states together to form a large resultant meta state. This approach provides for inferring the joint data association by characterization of all possible associations between objects and observations using any of a variety of known techniques. Though successful for many purposes, unfortunately such approaches are neither a comprehensive solution nor always a desirable approach in and of themselves.

As one example in this regard, these approaches tend to handle an error merge problem at tremendous computational cost due to the complexity inherent to the high dimensionality of the joint state representation. In general, this complexity tends to grow exponentially with respect to the number of objects being tracked. As a result, in many real world applications these approaches are simply impractical for real-time purposes.

Many existing approaches make use of only monocular views. This, however, poses additional problems. A monocular approach imposes challenges with respect to multi-target occlusion as well as the lack of relative depth information. Multiple image sources, having different points of view, have been proposed but the use of multiple cameras has itself raised a number of considerable challenges. These include difficulties regarding, for example, establishing consistent label correspondence of a same target among the different points of view as well as the integration of the information being provided for the different points of view.

### BRIEF DESCRIPTION OF THE DRAWINGS

The above needs are at least partially met through provision of the method and apparatus to facilitate use of conditional probabilistic analysis of multi-point-of-reference samples of an item to disambiguate state information as pertains to the item described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a model as configured in accordance with various embodiments of the invention;

FIG. 4 comprises a model as configured in accordance with various embodiments of the invention;

FIG. 5 comprises a model as configured in accordance with various embodiments of the invention;

FIG. 6 comprises a model as configured in accordance with various embodiments of the invention;

FIG. 7 comprises a schematic depiction as configured in accordance with various embodiments of the invention;

FIG. 8 comprises a model as configured in accordance with various embodiments of the invention; and

FIG. 9 comprises a schematic state diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, temporally parsed data regarding at least a first item is captured. This temporally parsed data comprises data that corresponds to substantially simultaneous samples of the first item with respect to at least a first and a second different points of view. Conditional probabilistic analysis of at least some of this temporally parsed data is then automatically used to disambiguate state information as pertains to this first item. This conditional probabilistic analysis comprises analysis of at least some of the temporally parsed data as corresponds in a given sample to both the first point of reference and the second point of reference.

In cases where there is more than one such item, if desired, these teachings will further accommodate automatically using, at least in part, disjoint probabilistic analysis of the temporally parsed data as pertains to multiple such items to disambiguate state information as pertains to a given one of the points of reference for the first item from information as pertains to the given one of the points of reference for a second such item.

So configured, these teachings facilitate the use of multiple data capture points of view when disambiguating state information for a given item. These teachings achieve such disambiguation in a manner that requires considerably less computational capacity and capability than might otherwise be expected. In particular, these teachings are suitable for use in substantially real-time monitoring settings where a relatively high number of items, such as pedestrians or the like, are likely at any given time to be visually interacting with one another in ways that would otherwise tend to lead to confused or ambiguous monitoring results when relying only upon relatively modest computational capabilities.

Furthermore, and as will be evident below, these teachings provide a superior solution to multi-target occlusion problems by leveraging the availability of multiocular videos. These teachings permit avoidance of the computational complexity that is generally inherent in centralized methods that rely on joint-state representation and joint data association.

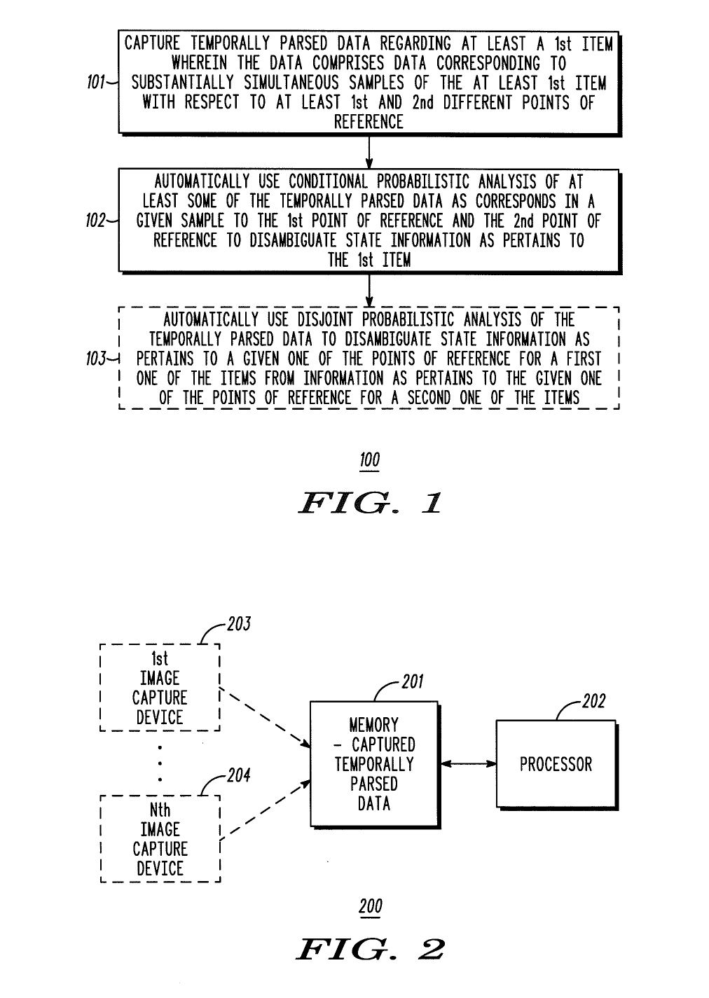

These and other benefits may become clearer upon making a thorough review and study of the following detailed description. Referring now to the drawings, and in particular to FIG. 1, an illustrative process 100 in these regards provides for capturing 101 temporally parsed data regarding at least a first item. This item could comprise any of a wide variety of objects including but not limited to discernable energy waves such as discrete sounds, continuous or discontinuous sound streams from multiple sources, radar images, and so forth. In many application settings, however, this item will comprise a physical object or, perhaps more precisely, images of a physical object.

This activity of capturing temporally parsed data can therefore comprise, for example, providing a video stream as provided by data capture devices of a particular scene (such as a scene of a sidewalk, an airport security line, and so forth) where various of the frames contain data (that is, images of objects) that represent samples captured at different times. Although, as noted, such data can comprise a wide variety of different kinds of objects, for the sake of simplicity and clarity the remainder of this description shall presume that the objects are images of physical objects unless stated otherwise. Those skilled in the art will recognize and understand that this convention is undertaken for the sake of illustration and is not intended as any suggestion of limitation with respect to the scope of these teachings.

Pursuant to these teachings, this activity of capturing temporally parsed data can comprises capturing temporally parsed data regarding at least a first item, wherein the temporally parsed data comprises data corresponding to substantially simultaneous samples of the at least first item with respect to at least first and second different points of reference. This can comprise, for example, providing data that has been captured using at least two cameras that are positioned to have differing view of the first item.

It will be understood and recognized by those skilled in the art that such cameras can comprise any combination of similar or dissimilar cameras: true color cameras, enhanced color cameras, monochrome cameras, still image cameras, video capture cameras, and so forth. It would also be possible to employ cameras that react to illumination sources other than visible light, such as infrared cameras or the like.

This process 100 then provides for automatically using 102, at least in part, conditional probabilistic analysis of at least some of the temporally parsed data as corresponds in a given sample to the first point of reference and the second point of reference to disambiguate state information as pertains to the first item. By one approach, for example, this can comprise using conditional probabilistic analysis with respect to state information as corresponds to the first item. This can also comprise, if desired, determining whether to use a joint conditional probabilistic analysis or a non-joint conditional probabilistic analysis as will be illustrated in more detail below. And, if desired, this can also comprise determining whether to use such conditional probabilistic analysis for only some of the temporally parsed data or for substantially all (or all) of the temporally parsed data as corresponds to the given sample.

As noted above, this process 100 will accommodate the use of data as corresponds to more than one item. When temporally parsed data comprises data corresponding to substantially simultaneous samples regarding at least a first item and a second item with respect to at least a first and a second different points of reference, the aforementioned step regarding disambiguation can further comprise automatically using conditional probabilistic analysis of at least some of the temporally parsed data to also disambiguate state information as pertains to the first item from information as pertains to the second item.

When multiple items are present, these teachings will also accommodate, if desired, optionally automatically using 103, at least in part, disjoint probabilistic analysis of the temporally parsed data to disambiguate state information as pertains to a given one of the points of reference for the first item from information as pertains to the given one of the points of reference for the second item. (A complete description of such analysis can be found in a patent application entitled METHOD AND APPARATUS TO DISAMBIGUATE STATE INFORMATION FOR MULTIPLE ITEMS TRACKING as was filed on Oct. 13, 2006 and which was assigned application Ser. No. 11/549,542, the contents of which are fully incorporated herein by this reference.) This, in turn, can optionally comprise using epipolar geometry within a sequential Monte Carlo implementation to substantially avoid attempting to match first item features with second item features. Generally speaking, by one approach, these teachings will accommodate using a distributed Bayesian framework to facilitate multiple-target tracking using multiple collaborative cameras. Viewed generally, these teachings facilitate provision and use of a multiple-camera collaboration model using epipolar geometry to estimate the camera collaboration function efficiently without requiring recovery of the targets' three dimensional coordinates.

A more detailed presentation of a particular approach to effecting such an approach by use of multiple collaborative cameras will now be provided. Again, those skilled in the art will understand and appreciate that this more-detailed description is provided for the purpose of illustration and not by way of limitation with respect to the scope or reach of these teachings.

This example presumes the use of multiple trackers; in particular, one tracker per target in each camera view for multiple-target tracking in multiocular videos. Although this specific example refers to only two cameras for the sake of simplicity and clarity, these teachings can be easily generalized to cases using more cameras.

For the purposes of this explanation, the state of a target in a first camera (referred to hereafter as camera A) is denoted by Xₜ^{A,i}, where i=1, . . . , M is the index of targets, and t is the time index. The image observations of Xₜ^{A,i} by Zₜ^{A,i} are denoted by the set of all states up to time t by X_{0:t}^{A,i}, where X₀^{A,i} is the initialization prior, and the set of all observations up to, time t by Z_{1:t}^{A,i}. One can similarly denote the corresponding notions for targets in a second camera (denoted hereafter as camera B). For instance, the “counterpart” of Xₜ^{A,i} is Xₜ^{B,i}. This explanation further uses Zₜ^{A,J}^{ₜ} to denote the neighboring observations of Zₜ^{A,i}, which “interact” with at time Zₜ^{A,i} where Jₜ={jₗ₁, jₗ₂, . . . }. (This example defines a target to have “interaction” when it touches or occludes other targets in a given camera view.)

The elements jₗ₁, jₗ₂, . . . ε{1, . . . , M}, jₗ₁, jₗ₂, . . . ≠i, are indexes of targets whose observations interact with Zₜ^{A,i}. When there is no interaction of Zₜ^{A,i} with other observations at time t, Jₜ=Ø. Since the interaction structure among observations is changing, J may vary in time. In addition, Z_{1:t}^{A,J}^{_{1:i}} represents the sequence of neighboring observation vectors up to time t.

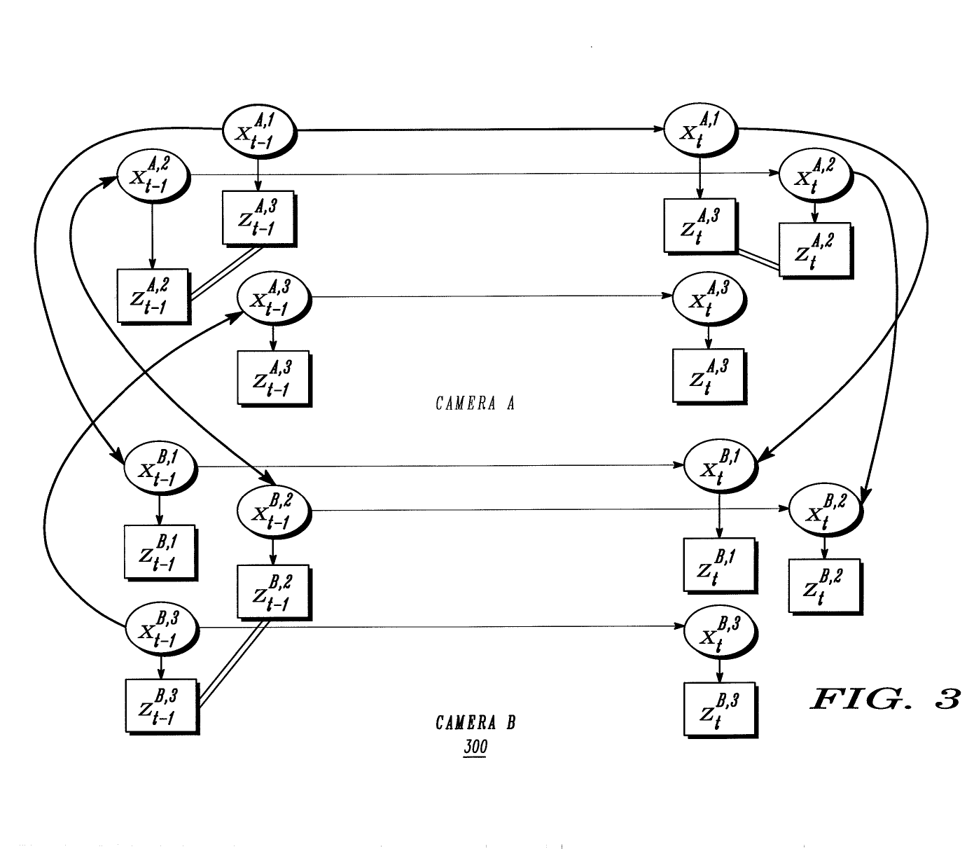

Graphical models comprise an intuitive and convenient tool to model and analyze complex dynamic systems. FIG. 3 illustrates a dynamic graphical model 300 of two consecutive frames for multiple targets in two collaborative cameras (i.e., camera A and camera B). Each camera view has two layers: a hidden layer has circle modes representing the targets' states and an observable layer has square nodes representing the observations associated with the hidden states. The directed link between consecutive states of the same target in each camera represents the state dynamics. The directed link for a target's state to its observation characterizes the local observation likelihood. The undirected link in each camera between neighboring observation nodes represents the “interaction.”

Pursuant to these teachings one activates the interaction only when the targets' observations are in close proximity or occlusion. This can be approximately determined by the spatial relation between the targets' trackers since the exact locations of observations are typically unknown.

The directed curve link between the counterpart states of the same target in two cameras represents the “camera collaboration.” This collaboration is activated between any possible collection of cameras only for targets which need help to improve their tracking robustness. For instance, such help may be needed when the targets are close to occlusion or are possibly completely occluded by other targets in a camera view. The direction of the link shows which target resorts to which other targets for help. This need driven-based scheme avoids performing camera collaboration at all times and for all targets; thus, a tremendous amount of computation is saved.

As one illustrative example in this regard, and with continued reference to FIG. 3, all targets in camera B at time t do not need to activate the camera collaboration because their observations do not interact with the other targets' observations at all. In this case, each target can be robustly tracked using independent trackers. On the other hand, targets 1 and 2 in camera A at time t can serve to activate camera collaboration since their observations interact and may undergo multi-target occlusion. Therefore, external information from other cameras may be helpful to make the tracking of these two targets more stable.

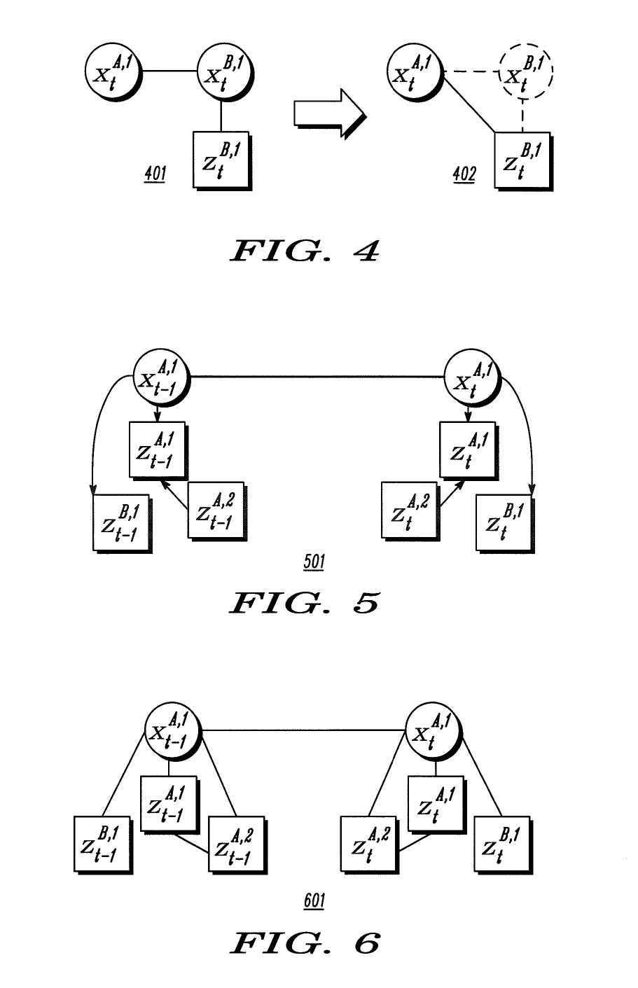

A graphical model as shown in FIG. 3 is suitable for centralized analysis using joint-state representations. To minimize computational costs, however, one may choose a completely distributed process where multiple collaborative trackers, one tracker per target in each camera, are used for multi-target tracking purposes simultaneously. Consequently, one can further decompose the graphical model for every target in each camera by performing four steps: (1) each submodel aims at one target in one camera; (2) for analysis of the observations of a specific camera, only neighboring observations which have direct links to the analyzed target's observation are kept; i.e., all the nodes of both non-neighboring observations which have direct links to the analyzed target's observation are kept; (3) each undirected “interaction” link is decomposed into two different directed links for the different targets (the direction of the link is from the other target's observation to the analyzed target's observation); and (4) since the “camera collaboration” link from a target's state in the analyzed camera view to its counterpart state in another view and the link from this counterpart state to its associated observation have the same direction, this causality can be simplified by a direct link from the grandparent node 401 to its grandson 402 as illustrated in FIG. 4.

FIG. 5 illustrates the decomposition result 501 of target 1 in camera A. Although this process neglects some indirectly related nodes and links and thus simplifies the distributed graphical model when analyzing a certain target, the neglected information is not lost but has been taken into account in the other targets' models. Therefore, when all the trackers are implemented simultaneously, the decomposed subgraphs together capture the original graphical model.

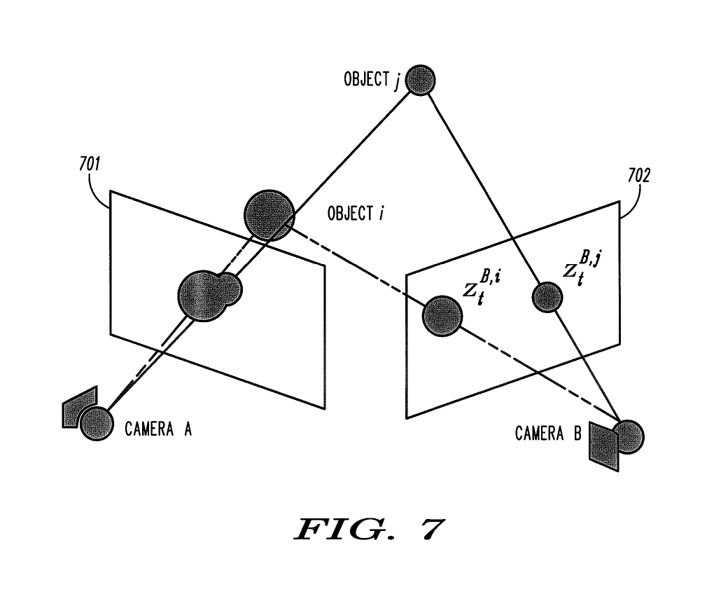

According to graphical model theory, one can analyze the Markov properties (that is, the conditional independence properties) for every decomposed graph on its corresponding moral graphs 601 as illustrated in FIG. 6. Then by applying a separation theorem as is known in the art, the following Markov properties can be substantiated:

p<xₜ^{A,i}, Zₜ^{A,J,}Zₜ^{B,i}|X_{0:t}^{A,i}, Z_{1:t-1}^{A,l}, Z_{1:t-1}^{A,J}^{_{1:t−1}}, Z_{1:t-1}^{B,i}>=p<Xₜ^{A,i}, Zₜ^{A,J}^{ₜ}Zₜ^{B,i}|X_{0:t-1}^{A,i}>, (i)

p<Zₜ^{A,J}^{ₜ}, Zₜ^{B,i}|Xₜ^{A,i}, X_{0:t 1}^{A,i}>=p<Zₜ^{A,J}^{ₜ}, Zₜ^{B,i|X}ₜ^{A,i}>, (ii)

p<Zₜ^{A,i}|X_{0:l}^{A,i}, Z_{l:l-1}^{A,i}, Z_{l:t}^{A,J}^{_{lz}}, Z_{l:t}^{B,i}>=p<Zₗ^{A,i}|Xₗ^{A,l}, Z_{1:t-1}^{A,i}, Zₜ^{A,J}^{ₜ}, Z_{1:t}^{B,i}>, (iii)

p<Zₜ^{B,i}|Xₜ^{A,i}, Zₜ^{A,i}>=p<Zₜ^{B,i}|Xₜ^{A,i}> (iv)

p<Zₜ^{A,J}^{ₜ}, Zₜ^{B,i}|Xₜ^{A,i}, Zₜ^{A,i}>=p<Zₜ^{A,j}^{ₜ}|Xₜ^{A,i}, Zₜ^{A,i}>p<Zₜ^{B,i}|Xₜ^{A,i}, Xₜ^{A,i}> (v)

One may now consider a Bayesian conditional density propagation structure for each decomposed graphical model as illustrated in FIGS. 4 and 5. One objective in this regard is to provide a generic statistical structure to model the interaction among cameras for multi-camera tracking. Since this process proposes using multiple collaborative trackers, one tracker per target in each camera view, for multi-camera multi-target tracking, one can dynamically estimate the posterior based on observations from both the target and its neighbors in the current camera view as well as the target in other camera views, that is, p(x_{0:t}^{A,i}|z_{1:t}^{A,i}, z_{1:t}^{A,j}^{_{l:t}}, z_{l:t}^{B,L}) for each tracker and for each camera view.

By applying Bayes's rule and the Markov properties derived in the previous section, a recursive conditional density updating rule can be obtained by:

$$\begin{matrix}\begin{matrix}p 〈 {x}_{0 \text{:} t}^{A , i} \vert {z}_{1 : t - 1}^{A , i} , {z}_{1 \text{:} t}^{A , {J}_{1 : t}} , {z}_{1 \text{:} t}^{B , i} 〉 = {k}_{t} p 〈 {z}_{t}^{A , i} \vert {x}_{t}^{A , i} 〉 p 〈 {x}_{t}^{A , i} \vert {x}_{0 \text{:} t - 1}^{A , i} 〉 \\ p 〈 {z}_{t}^{A , {J}_{t}} \vert {x}_{t}^{A , i} , {z}_{t}^{A , i} 〉 Xp 〈 {z}_{t}^{B , i} \vert {x}_{t}^{A , i} 〉 \\ p 〈 {x}_{0 \text{:} t - 1}^{A , i} \vert {z}_{1 \text{:} t - 1}^{A , i} , {z}_{1 \text{:} t - 1}^{A , {J}_{1 \text{:} t - 1}} , {z}_{1 \text{:} t - 1}^{B , i} 〉 ,\end{matrix} \\ where & ( 1 ) \\ {k}_{t} = \frac{1}{p 〈 {z}_{t}^{A , i} , {z}_{t}^{A , {J}_{t}} , {z}_{t}^{B , i} \vert {z}_{1 \text{:} t - 1}^{A , i} , {z}_{1 \text{:} t - 1}^{A , {J}_{1 : t - 1}} , {z}_{1 \text{:} t - 1}^{B , i} 〉} & ( 2 )\end{matrix}$$

Those skilled in the art will note that the normalization constant kₜ does not depend on the states X_{0:t}^{A,j}. In (1), p<Zₜ^{A,i}|Xₜ^{A,i}> is the local observation likelihood for target i in analyzed camera view A, and p<Xₜ^{A,i}|X_{0:t 1}^{A,i}> represents the state dynamics, which are similar to traditional Bayesian tracking methods. And, p<Zₜ^{A,J}^{₁}|Xₗ^{A,i}, Zₜ^{A,i}> is the “target interaction function” within each camera that can be estimated by using a so-called magnetic repulsion model as is known in the art. A novel likelihood density p<Zₜ^{B,i}|Xₜ^{A,i}> can be introduced to characterize the collaboration between the same target's counterparts in different camera views. This is referred to herein as a “camera collaboration function.”

When not activating the camera collaboration for a target and regarding its projections in different views as independent, the proposed Bayesian multiple-camera tracking framework can be identical to the Interactively Distributed Multi-Object Tracking (IDMOT) approach which is known in the art, where p<Zₜ^{B,i}|Xₜ^{A,i}> is uniformly distributed. When deactivating the interaction among the targets' observations, such a formulation can further reduce to traditional Bayesian tracking, where p<Zₜ^{A,J}^{₁}|Xₜ^{A,i}, Zₜ^{A,i}> is also uniformly distributed.

Since the posterior of each target is generally non-Gaussian, one can posit a nonparametric implementation of the derived Bayesian formulation using the sequential Monte Carlo algorithm, in which a particle set is employed to represent the posterior

p(x_{0:t}^{A,i}|z_{l:t}^{A,i}, z_{l:t}^{A,j}^{_{l:t}}, z_{l:t}^{B,i})˜<X_{0:t}^{A,i,n}, Wₜ^{A,i,n}>ₘ₌₁^{Np}, (3)

where {X_{0:t}^{A,i,n}, n=1, Nₚ} are the samples, {Wₜ^{A,i,n}, n=1 Nₚ} are associated weights, and Nₚ is the number of samples.

Considering the derived sequential iteration in (1), if the particles X_{0:t}^{A,i,n} are sampled from the importance density function q<Xₜ^{A,i}|X_{0:t-1}^{A,i,n}, Z_{1:t}^{A,J}^{_{1:t}}, Z_{1:t}^{B,i}>=p<Xₜ^{A,i}|X_{0:t-1}^{A,i,n}>, the corresponding weights are given by

Wₜ^{i,n}∝Wₜ₋₁^{i,n}p<Zₜ^{A,i}|Xₜ^{A,i,n}>p<Zₜ^{A,J}^{ᵢ}|Xₜ^{A,i,n}Zₜ^{A,i}>p<Zₜ^{B,i}|Xₜ^{A,i,n}> (4)

It has been widely accepted that better importance density functions can make particles more efficient. Accordingly one can choose a relatively simple function p<Xₗ^{A,i}|Xₜ₋₁^{A,u}> to highlight the efficiency of using camera collaboration. Other importance densities as are known in the art can also be used to provide better performance as desired.

Modeling the densities in (4) is not necessarily trivial and can have great influence on the performance of practical implementations. A proper model can play a significant role in estimating the densities. Different target models, such as a 2D ellipse model, a 3D object model, a snake or dynamic contour model, and so forth, are known in the art. One may also employ a five-dimensional parametric ellipse model that is quite common in the prior art, saves a lot of computational costs, and is sufficient to represent the optical tracking results for these purposes. For example, the state Xₜ^{A,i} is given by (cxₜ^{A,i},cyₜ^{A,i},aₜ^{A,i},bₜ^{A,i},pₜ^{A,i}), where i=1, . . . , M is the index of targets, t is the time index, (cx, cy) is the center of the ellipse, a is the major axis, b is the minor axis, and p is the orientation in radians.

Those skilled in the art will recognize that the proposed Bayesian conditional density propagation framework has no specific requirements of the cameras (e.g., fixed or moving, calibrated or not, and so forth) and the collaboration model (e.g., 3D/2D) as long as the model can provide a good estimation of the density p<Zₜ^{B,i}|Xₜ^{A,i}>. Epipolar geometry has been used to model the relation across multiple camera views in different ways. Somewhat contrary to prior uses of epipolar geometry, however, the present teachings will accommodate presenting a paradigm of camera collaboration likelihood modeling that uses sequential Monte Carlo implementation that does not require feature matching and recovery of the target's 3D coordinates, but only assumes that the cameras' epipolar geometry is known.

FIG. 7 illustrates a model setting in 3D space. Two targets i and j are projected onto two camera views 701 and 702 respectively. In view 701, the projections of targets i and j are very close (occluding) while in view 702, they are not. In such situations, these teachings will accommodate only activating the camera collaboration for trackers of targets i and j in view 701 but not in view 702 in order to conserve computational requirements.

These teachings then contemplate mapping the observation Zₜ^{B,i} to camera view 701 and calculating the density there. The observations Zₜ^{B,i} and Zₜ^{B,j} are initially found by tracking in view 702. Then, they are mapped to view 701, producing h(Zₜ^{B,i}) and h(Zₜ^{B,j}), where h(·) is a function of Zₜ^{B,i} or Zₜ^{B,j} characterizing the epipolar geometry transformation. After that, the collaboration likelihood can be calculated based on h(Zₜ^{B,i}) and h(Zₜ^{B,j}). Sometimes, a more complicated case occurs, for example, target i is occluding with others in both cameras. In this situation, the above scheme is initialized by randomly selecting one view, say, view 702, and using IDMOT to find the observations. These initial estimates may not be very accurate; therefore, in this case, one can iterate several times (usually twice is enough) between different views to get more stable estimates.

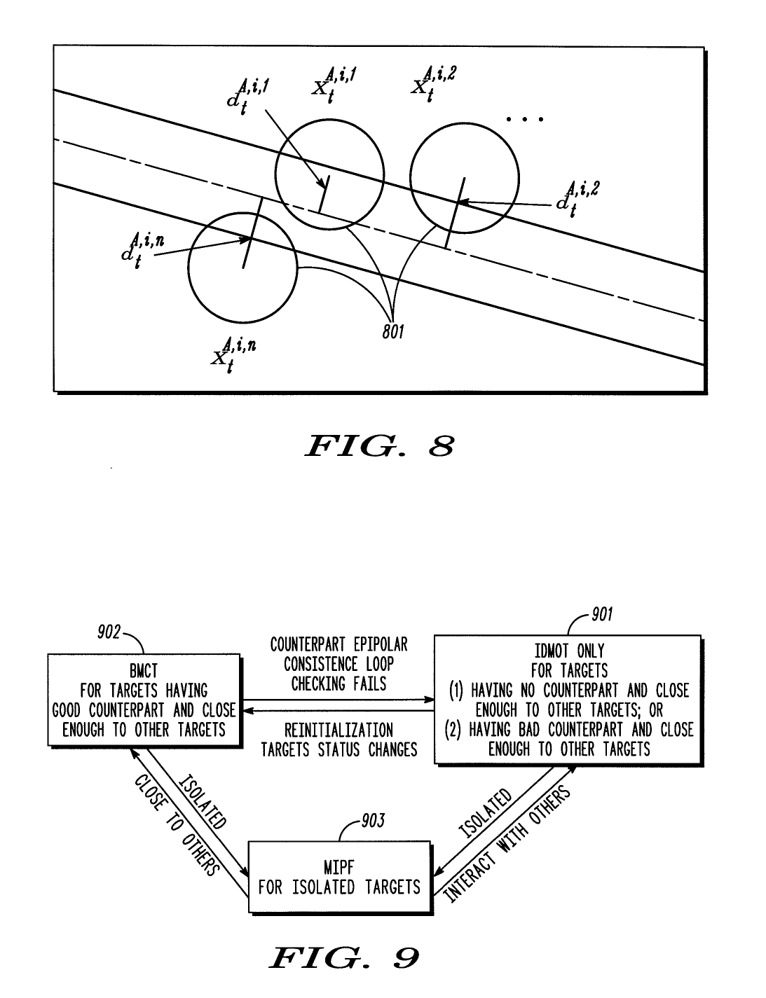

FIG. 8 illustrates a procedure used to calculate the collaboration weight for each particle based on h(Zₜ^{B,i}). The particles <Xₜ^{A,i,l}, Xₜ^{A,i,2}, . . . , Xₜ^{A,i,n}> are represented by the circles 801 instead of the ellipse models for simplicity. Given the Euclidean distance dₜ^{A,i,n}=∥Xₜ^{A,i,n}−h(Zₜ^{B,i})∥ between the particle Xₜ^{A,i,n} and the band h(Zₜ^{B,i}), the collaboration weight for particle Xₜ^{A,i,n} can be computed as

$${φ}_{t}^{A , i , n} = \frac{1}{\sqrt{2 π {\sum }_{φ}}} exp \{ - \frac{{( {d}_{t}^{A , i , n} )}^{2}}{2 {\sum }_{ϕ}^{2}} \} , \\ Where {\sum }_{φ}^{2} \qquad ( 5 )$$

is the variance that can be chosen as the bandwidth. In FIG. 8, one can simplify dₜ^{A,i,n} by using a point-line distance between the center of the particle and the middle line of the band. Furthermore, the camera collaboration likelihood can be approximated as follows:

$$p 〈 {z}_{t}^{B , i} \vert {x}_{t}^{A , i} 〉 \approx {\sum }_{n = 1}^{Np} \frac{{φ}_{t}^{A . i , n}}{{\sum }_{{n}^{′} = 1}^{Np} {φ}_{t}^{A , i , {n}^{′}}} δ ( {x}_{t}^{A , i} - {x}_{t}^{A , i , n} ) . \qquad ( 6 )$$

A so-called “magnetic repulsion model” can be employed thusly:

$$p 〈 {z}_{t}^{A , {J}_{t}} \vert {x}_{t}^{A , i} {z}_{t}^{A , i} 〉 \approx {\sum }_{n = 1}^{Np} \frac{{φ}_{t}^{A . i , n}}{{\sum }_{{n}^{′} = 1}^{Np} {φ}_{t}^{A , i , {n}^{′}}} δ ( {x}_{t}^{A , i} - {x}_{t}^{A , i , n} ) , \qquad ( 7 )$$

where φₗ^{A,i,n} is the interaction weight of particle Xₜ^{A,i,n}. It can be iteratively calculated by

$${φ}_{t}^{A , i , n} = 1 - \frac{1}{α} exp \{ - \frac{{( {l}_{t}^{A , i , n} )}^{2}}{{\sum }_{ϕ}^{2}} \} , \qquad ( 8 )$$

where α and Σ_{φ} are constants and lₗ^{A,i,n} is the distance between the current particle's observation and the neighboring observation.

Different cues have been proposed to estimate the local observation likelihood. For present purposes one can fuse the target's color histogram with a PCA-based model, namely, p<Zₜ^{A,i}|Xₜ^{A,i}>=p_{c}×pₚ, where p_{c} and pₚ are the likelihood estimates obtained from the color histogram and PCA models, respectively.

For simplicity, one can manually initialize all the targets for experimental or calibration purposes. Many automatic initialization algorithms are available and can be used instead as desired.

To minimize computational cost, one may wish to avoid activating such camera collaboration when targets are far away from each other since a single-target tracker can achieve reasonable performance under such operating conditions. Moreover, some targets cannot utilize the camera collaboration even when they are occluding with others if these targets have no projections in other views. Therefore, a tracker can be configured to activate the camera collaboration and thus implement the proposed Bayesian multiple-camera tracking only when its associated target needs and can do so. In other situations, the tracker will degrade to implement IDMOT or a traditional Bayesian tracker such as multiple independent regular particle filters.

FIG. 9 illustrates an approach in this regard. One can use counterpart epipolar consistence loop checking to check if the projections of the same target in different views are on each other's epipolar line (band). With this in mind, it can further be noted that every target in each camera view is in one of the following three situations:
Has a good counterpart (the target and its counterpart in other views satisfy the epipolar consistence loop check; in such a case only such targets are used to activate the camera collaboration);
Has a bad counterpart (the target and its counterpart do not satisfy the epipolar consistence loop check which means that at least one of their trackers made a mistake; such targets will not activate the camera coloration to avoid additional error);
Has no counterpart (this occurs when the target has no projection in other views at all).
   The targets having a bad counterpart or having no counterpart can implement a degraded Bayesian multiple-camera tracking approach, namely, IDMOT 901. These trackers can be upgraded back to Bayesian multiple-camera tracking 902 after reinitialization, when the status may change to having a good counterpart.

Within a camera view, if the analyzed tracker is isolated from other targets, it will only implement multiple independent regular particle filters (MIPF) 903 to reduce the computational costs. When it becomes closer or interacts with other trackers, it can activate either BMCT 902 or IDMOT 901 according to the associated targets' status. This approach tends to ensure that the proposed Bayesian multiple-camera tracing approach using multiocular videos can work better and is, in any event, never inferior to monocular video implementations of IDMOT or MIPF.

If desired, the tracker can be configured to have the capability to decide that the associated target has disappeared and should be deleted in either of two cases: (1) the target moves out of the image; or (2) the tracker loses the target and tracks clutter instead. In both situations, the epipolar consistence loop checking fails and the local observation weights of the tracker's particles become very small since there is no target information any more. On the other hand, in the case where the tracker misses its associated target and follows a false target, these processes will not delete the tracker and instead leave it for further evaluation.

There are three different likelihood densities that are beneficially estimated in this Bayesian multiple-camera tracking architecture: (1) local observation likelihood p<Zₜ^{A,i}|Xₜ^{A,i}>; (2) target interaction likelihood p<Zₜ^{A,J}^{ₜ}|Xₜ^{A,i}Zₜ^{A,i}> within each camera; and (3) camera collaboration likelihood p<Zₜ^{B,i}|Xₜ^{A,i}>. The weighting complexity of these likelihoods are the main factors which impact the entire system's computational cost.

TABLE 1
Average computational time comparison of different
likelihood weightings

| Local observation | Target interaction | Camera collaboration |
|---|---|---|
| Likelihood | likelihood | likelihood |
| 0.057 s | 0.0057 s | 0.003 s |

In Table 1, a comparison appears as to the average computation time of the different likelihood weightings in processing one frame of synthetic sequences using Bayesian multiple-camera tracking as per these teachings. Compared with the most time-consuming component (which is the local observation likelihood weighting of traditional particle filters), the computational cost required for camera collaboration is negligible. This is primarily because of two reasons: firstly, a tracker activates the camera collaboration only when it encounters potential multi-target occlusions; and secondly, this epipolar geometry-based camera collaboration likelihood model avoids feature matching and is very efficient.

The computational complexity of the centralized approaches used for many prior art multi-target tracking approaches increases exponentially in terms of the number of targets and cameras since the centralized methods rely on joint-state representations. The computational complexity of the proposed distributed architecture, on the other hand, increases linearly with the number of targets and cameras. Table 2 presents a comparison of the complexity of these two modes in terms of the number of targets by running the proposed Bayesian multiple-camera tracking approach and a joint-state representation-based MCMC particle filter (the data was obtained by varying the number of targets on synthetic videos). It can be seen that under the condition of achieving reasonable robust tracking performance, both the required number of particles and the speed of the proposed Bayesian multiple-camera tracking approach vary linearly.

TABLE 2
Complexity analysis in terms of the number of targets.

| | | Total targets number | | |
|---|---|---|---|---|
| | | 4 | 5 | 6 |
| Total | MCMC-PF | 500 | 1100 | 2800 |
| particles | BMCT | 400 | 500 | 600 |
| Speed | MCMC-PF | 8.5~9 | 2.1~3 | 0.3~0.5 |
| (fps) | BMCT | 13.8~9 | 11~12 | 9~10.5 |

These teachings are therefore seen to provide a Bayesian strucure that solves the multi-target occlusion problem for multiple-target tracking application settings that use multiple collaborative cameras. Compared with the common practice of using a joint-state representation whose computational complexity increases exponentially with the number of targets and cameras, the proposed approach solves the multi-camera multi-target tracking problem in a distributed way whose complexity grows only linearly with the number of targets and cameras.

Moreover, the proposed approach presents a very convenient architecture for tracker initialization of new targets and tracker elimination of vanished targets. The distributed architecture also makes it very suitable for efficient parallelization in complex computer networking applications. The proposed approach does not recover the targets' 3D locations. Instead, it generates multiple estimates, one per camera, for each target in the 2D image plane. For many practical tracking applications such as video surveillance, this is sufficient since the 3D target location is usually not necessary and 3D modeling will require a very expensive computational effort for precise camera calibration and nontrivial feature matching.

The merits of this Bayesian multiple-camera tracking approach compared with 3D tracking approaches include speed, ease of implementation, graceful degradation (fault tolerance), and robust (noise resilient) tracking results in crowded environments. In addition, with the necessary camera calibration information, the 2D estimates can also be projected back to recover the targets' 3D location in the world coordinate system. Furthermore, these teachings present an efficient collaboration model using epipolar geometry with sequential Monte Carlo implementation. This avoids the need for recovery of the targets' 3D coordinates and does not require feature matching, which is difficult to perform in widely separated cameras.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment, the apparatus 200 comprises a memory 201 that operably couples to a processor 202. The memory 201 serves to store and hold available the aforementioned captured temporally parsed data regarding at least a first item, wherein the data comprises data corresponding to substantially simultaneous samples of the first item (and other items when present) with respect to at least first and second differing points of reference. Such data can be provided by, for example, a first 203 through an Nth image capture device 204 (where N comprises an integer greater than one) that are each positioned to have differing views of the first item.

The processor 202, in turn, is configured and arranged to effect selected teachings as have been set forth above. This includes, for example, automatically using, at least in part, conditional probabilistic analysis of at least some of the temporally parsed data as corresponds in a given sample to the first point of reference and the second point of reference to disambiguate state information as pertains to the first item.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
capturing temporally parsed data regarding at least a first item, wherein the temporally parsed data comprises data corresponding to substantially simultaneous samples of the at least first item with respect to at least first and a second different points of reference;
automatically using, at least in part, conditional probabilistic analysis of at least some of the temporally parsed data as corresponds in a given sample to:
the first point of reference; and
the second point of reference;
to disambiguate state information as pertains to the first item.

2. The method of claim 1 wherein capturing temporally parsed data comprises, at least in part, capturing the temporally parsed data using at least two cameras that are positioned to have differing views of the first item.

3. The method of claim 1 wherein automatically using, at least in part, conditional probabilistic analysis of at least some of the temporally parsed data comprises, at least in part, using conditional probabilistic analysis with respect to state information as corresponds to the first item.

4. The method of claim 1 wherein automatically using, at least in part, conditional probabilistic analysis of at least some of the temporally parsed data comprises, at least in part, determining whether to use a joint conditional probabilistic analysis or a non-joint conditional probabilistic analysis.

5. The method of claim 1 wherein automatically using, at least in part, conditional probabilistic analysis of at least some of the temporally parsed data comprises determining whether to use the conditional probabilistic analysis for all of the temporally parsed data as corresponds to the given sample.

6. The method of claim 1 wherein:
capturing temporally parsed data regarding at least a first item, wherein the temporally parsed data comprises data corresponding to substantially simultaneous samples of the at least first item with respect to at least first and a second different points of reference comprises capturing temporally parsed data regarding at least a first item and a second item, wherein the temporally parsed data comprises data corresponding to substantially simultaneous samples of the at least first item and second item with respect to at least first and a second different points of reference; and
automatically using, at least in part, conditional probabilistic analysis of at least some of the temporally parsed data to disambiguate state information as pertains to the first item comprises automatically using, at least in part, conditional probabilistic analysis of at least some of the temporally parsed data to disambiguate state information as pertains to the first item from information as pertains to the second item.

7. The method of claim 6 further comprising:
automatically using, at least in part, disjoint probabilistic analysis of the temporally parsed data to disambiguate state information as pertains to a given one of the points of reference for the first item from information as pertains to the given one of the points of reference for the second item.

8. The method of claim 6 wherein the conditional probabilistic analysis of at least some of the temporally parsed data to disambiguate state information as pertains to the first item from information as pertains to the second item further comprises using epipolar geometry within a sequential Monte Carlo implementation.

9. The method of claim 8 wherein using epipolar geometry within a sequential Monte Carlo implementation further comprises substantially avoiding attempting to match first item features with second item features.

10. An apparatus comprising:
a memory having captured temporally parsed data regarding at least a first item, wherein the temporally parsed data comprises data corresponding to substantially simultaneous samples of the at least first item with respect to at least first and a second different points of reference stored therein;
a processor operably coupled to the memory and being configured and arranged to automatically use, at least in part, conditional probabilistic analysis of at least some of the temporally parsed data as corresponds in a given sample to:
the first point of reference; and
the second point of reference;
to disambiguate state information as pertains to the first item.

11. The apparatus of claim 10 wherein the temporally parsed data comprises temporally parsed data that has been captured using at least two cameras that are positioned to have differing views of the first item.

12. The apparatus of claim 10 wherein the processor is further configured and arranged to automatically use, at least in part, conditional probabilistic analysis of at least some of the temporally parsed data by, at least in part, using conditional probabilistic analysis with respect to state information as corresponds to the first item.

13. The apparatus of claim 10 wherein the processor is further configured and arranged to automatically use, at least in part, conditional probabilistic analysis of at least some of the temporally parsed data by, at least in part, determining whether to use a joint conditional probabilistic analysis or a non-joint conditional probabilistic analysis.

14. The apparatus of claim 10 wherein the processor is further configured and arranged to automatically use, at least in part, conditional probabilistic analysis of at least some of the temporally parsed data by determining whether to use the conditional probabilistic analysis for all of the temporally parsed data as corresponds to the given sample.

15. The apparatus of claim 10 wherein:
the memory has captured temporally parsed data regarding at least a first item and a second item, wherein the temporally parsed data comprises data corresponding to substantially simultaneous samples of the at least first item and second item with respect to at least first and a second different points of reference stored therein; and
the processor is further configured and arranged to automatically use, at least in part, conditional probabilistic analysis of at least some of the temporally parsed data to disambiguate state information as pertains to the first item by automatically using, at least in part, conditional probabilistic analysis of at least some of the temporally parsed data to disambiguate state information as pertains to the first item from information as pertains to the second item.

16. The apparatus of claim 15 wherein the processor is further configured and arranged to automatically use, at least in part, disjoint probabilistic analysis of the temporally parsed data to disambiguate state information as pertains to a given one of the points of reference for the first item from information as pertains to the given one of the points of reference for the second item.

17. The apparatus of claim 15 wherein the conditional probabilistic analysis of at least some of the temporally parsed data to disambiguate state information as pertains to the first item from information as pertains to the second item comprises using epipolar geometry within a sequential Monte Carlo implementation.

18. The apparatus of claim 17 wherein the processor is further configured and arranged to use epipolar geometry within a sequential Monte Carlo implementation further by substantially avoiding attempting to match first item features with second item features.
